(19) United States
(12) Patent Application Publication
(10) Pub. No.: US 2026/0266425 A1
(43) Pub. Date: Sep. 10, 2026

(54) LUBRICATING A RAIL INTERFACE

(71) Applicant: Applied Materials Israel Ltd., Rehovot (IL)

(72) Inventors: Shmuel Nakash, Rehovot (IL); Marat Feldman, Rehovot (IL); Amit Yonaei, Rehovot (IL); Eran Dvir, Rehovot (IL); Oren Wass, Rehovot (IL)

(73) Assignee: Applied Materials Israel Ltd., Rehovot (IL)

(21) Appl. No.: 19/071,678

(22) Filed: Mar. 5, 2025

(51) Int. Cl. F16N 7/02; F16N 21/00

(52) U.S. Cl. CPC F16N 7/02; F16N 21/00; F16N 2210/14

(57) ABSTRACT

A system for lubricating a rail interface that is located within a vacuum chamber, the system includes (a) a lubricant reservoir that is configured store up to a defined amount lubricant that is suffice for performing multiple lubrication iterations; and (b) a lubricant delivery unit that is configured to selectively provide a lubricant suffice for performing a lubrication iteration, using gravity, to a lubricant inlet that is fluidly coupled to one or more parts of the rail interface.

### BACKGROUND OF THE INVENTION

A sample may be evaluated by an evaluation system by positioning the sample on a mechanical stage that is configured to move within a vacuum chamber. The mechanical stage is moved during an evaluation iteration, and additionally or alternatively, between one evaluations iteration to another.

The mechanical stage interfaces with one or more rails using one or more rail interfaces.

Each rail interface must be lubricated with a lubricant from time to time in order to seamlessly move along the rail.

The lubrication process involves opening the vacuum chamber, performing a lubrication iteration, and returning the vacuum chamber to a highly vacuumed chamber, which takes several hours, and dramatically reduces the throughput of the evaluation system.

There is a growing need to reduce the cost associated with the lubrication of the rail interface.

### BRIEF SUMMARY OF THE INVENTION

According to an embodiment, there is provided a system for lubricating a rail interface that is located within a vacuum chamber, the system includes (a) a lubricant reservoir that is configured store up to a defined amount lubricant that is suffice for performing multiple lubrication iterations; and (b) a lubricant delivery unit that is configured to selectively provide a lubricant suffice for performing a lubrication iteration, using gravity, to a lubricant inlet that is fluidly coupled to one or more parts of the rail interface.

According to an embodiment, there is provided a method for lubricating a rail interface that is located within a vacuum chamber, the method includes (a) storing, in a lubricant reservoir, up to a defined amount lubricant that is suffice for performing multiple lubrication iterations; and (b) selectively providing, by a lubricant delivery unit, a lubricant from the lubricant reservoir that is suffice for performing a lubrication iteration, using gravity, to a lubricant inlet that is fluidly coupled to one or more parts of the rail interface.

### BRIEF DESCRIPTION OF THE DRAWINGS

The subject matter regarded as the invention is particularly pointed out and distinctly claimed in the concluding portion of the specification. The invention, however, both as to organization and method of operation, together with specimen s, features, and advantages thereof, may best be understood by reference to the following detailed description when read with the accompanying drawings in which:

FIG. 1 illustrates an example of a system for lubricating a rail interface and its environment;

FIG. 2 illustrates an example of a system for lubricating a rail interface;

FIG. 3 illustrates an example of a system for lubricating a rail interface;

FIG. 4 illustrates an example of a system for lubricating a rail interface; and

FIG. 5 illustrates an example of a method.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

According to an embodiment there is provided a system and method for lubricating a rail interface located within a vacuum chamber.

According to an embodiment, there is provided a system for lubricating a rail interface that is located within a vacuum chamber, the system includes:
a. A lubricant reservoir that is configured store up to a defined amount lubricant that is suffice for performing multiple lubrication iterations. The multiple lubrication iterations may exceed 5, 10, 50, 20 and the like.
b. A lubricant delivery unit that is configured to selectively provide a lubricant suffice for performing a lubrication iteration, using gravity, to a lubricant inlet that is fluidly coupled to one or more parts of the rail interface.

Having the lubricant reservoir enables to open the vacuum chamber less frequently for example only once per the multiple lubrication iterations.

Having the lubricant delivery unit using gravity form selectively providing the lubricant reduces the contamination related to the provision of the lubricant- and there are no pump within the vacuum chamber.

According to an embodiment, when the rail interface has a lubricant inlet that does not face upward, the lubricant delivery system includes a lubricant interface that may have an upward opening and an oriented or vertical outlet for providing the lubricant to the lubricant inlet that does not face upward.

According to an embodiment, the alignment of the system and the lubricant inlet of the rail interface is accurate and easy to achieve by supporting at least a part of the system by a spring holder that holds springs the control and delimit the movement of the rail interface.

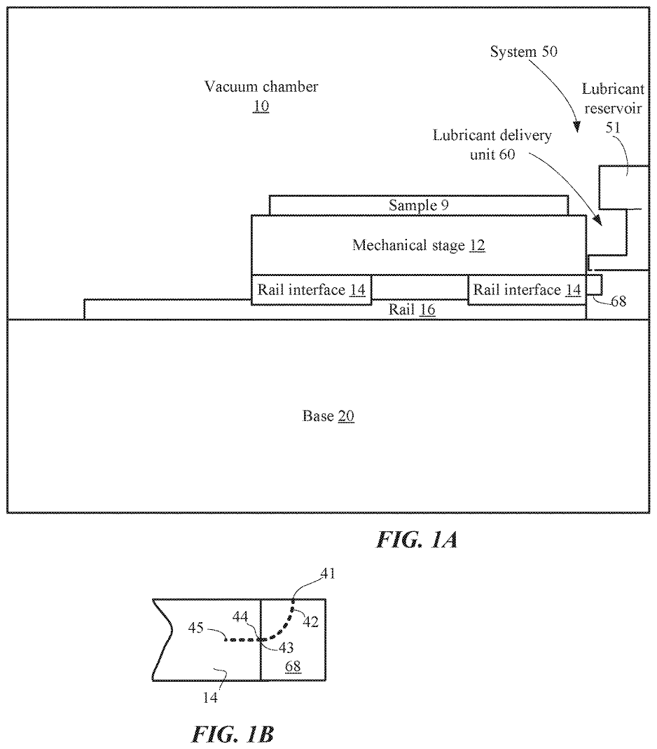

FIG. 1 illustrates system 50 for lubricating a rail interface and its environment. The environment includes an evaluation system that includes vacuum chamber 10, mechanical stage 12, rail interfaces 14, rail 16. FIG. 1 also illustrates a sample 9 that is located on mechanical stage 12. The sample 9, the system 50, the rail 16, the rail interfaces 14 and the mechanical stage and located within the vacuum chamber.

System 50 is illustrated as including:
a. Lubricant reservoir 51 that is configured store up to a defined amount lubricant that is suffice for performing multiple lubrication iterations.
b. Lubricant delivery unit 60 that is configured to selectively provide a lubricant suffice for performing a lubrication iteration, using gravity, to a lubricant inlet that is fluidly coupled to one or more parts of the rail interface. In FIG. 1 the lubricant delivery unit 60 is illustrated as including a rail interface 68 that extends from the rail interface and has an upward opening that received the lubricant and provides it to an input of the rail interface.

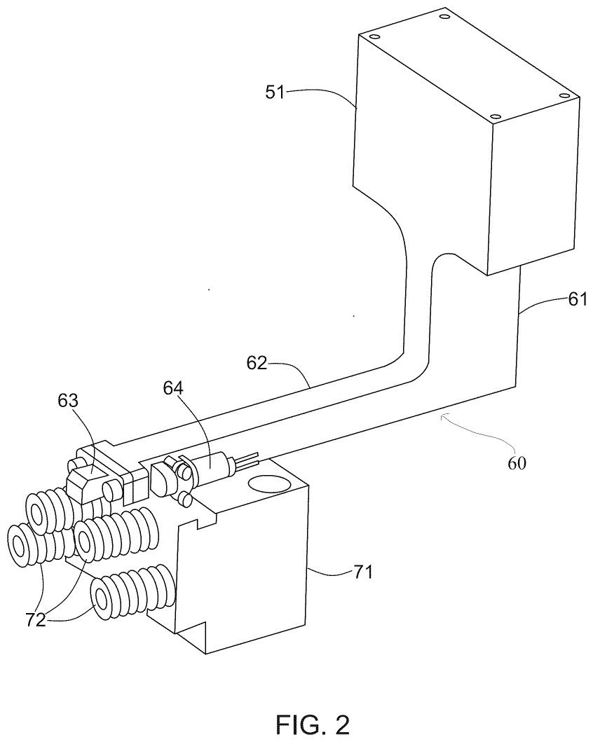

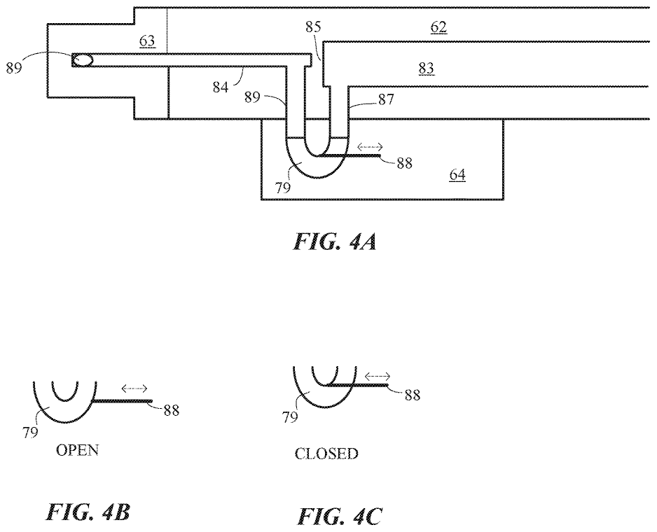

According to an embodiment, the lubricant delivery unit includes a valve (denoted 64 in FIGS. 2 and 4) that is opened during each lubrication iteration and is closed between lubrication iterations.

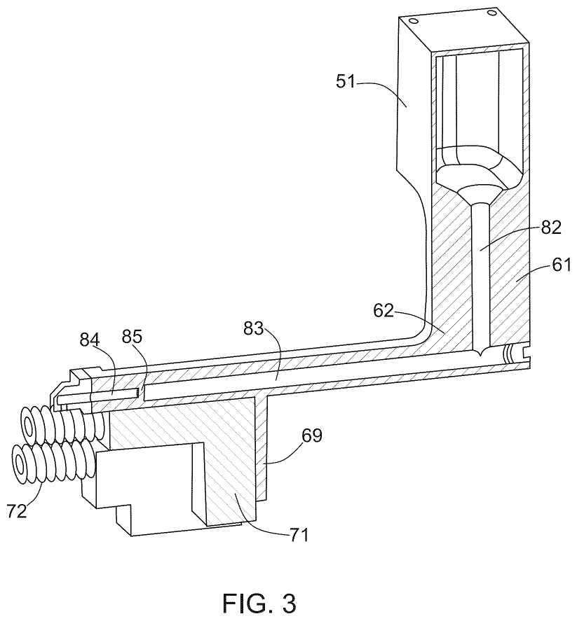

According to an embodiment, the lubricant delivery unit includes a first lubricant conduit in fluid communication with the lubricant reservoir and a second lubricant conduit in fluid communication with an outlet of the lubricant delivery unit. In FIGS. 3 and 4 the first lubricant conduit is denoted 83 and the second lubricant conduit is denoted 83.

According to an embodiment, the valve (denoted 64 in FIG. 4) is configured to selectively fluidly couple the first lubricant conduit to the second lubricant conduit. Referring to FIG. 4—the valve 64 has a movable segment 88 that is movable between an open position and a closed position. In FIG. 4 the movement is a linear movement along a longitudinal axis of the second lubricant conduit 84. It should be noted that the valve may be closed or opened using any mechanism that involves any type of movement—linear along any axis, rotational movement, and the like.

When the movable segment 88 is in a closed position the first lubricant conduit 83 is not fluidly coupled to the second lubricant conduit 84 as there is a barrier 85 between the first lubricant conduit 83 and the second lubricant conduit 84 first. There is a bypass path formed by first intermediate conduit 87, second intermediate conduit 89 and a valve conduit 79 is blocked by the movable segment.

When the movable segment 88 is in an open position the first lubricant conduit 83 is fluidly coupled to the second lubricant conduit 84 through the bypass path (formed by first intermediate conduit 87, second intermediate conduit 89 and valve conduit 79) and the lubricant from the lubricant reservoir (that is higher than the first lubricant conduit 83 and the second intermediate conduit 89) propagates till being outputted from an outlet 89 of a termination segment 63 that follows a second part 62 of the lubricant delivery unit.

Referring to FIG. 3—the first lubricant conduit 83 is formed within the second part 62 of the lubricant delivery unit. An initial lubricant conduit 82 is formed within a first part 61 of the lubricant delivery unit. In FIGS. 2 and 3 the first part 61 is vertical while the second part 62 is horizontal. Other spatial relationships may be provided.

In FIGS. 3 and 4, the first lubricant conduit is aligned with the second lubricant conduit. It should be noted that the first lubricant conduit may be misaligned with the second lubricant conduit.

According to an embodiment, the system includes a lubricant interface (denoted 68 in FIG. 1) that is mechanically coupled to the rail interface and includes the lubricant inlet. FIG. 1 illustrates that the lubricant interface 61 has an upward opening 41 followed by an inner conduit 42 and a vertical outlet 43 that is aligned with and is fluidly coupled to the input inlet 44 (of a rail interface) which is fluidly coupled to an inner conduit 45 of the rail interface.

According to an embodiment, the system includes a mechanical interface (denoted 69 in FIG. 3) for mechanically coupling the lubricant reservoir and at least a portion of the lubricant delivery unit to a support unit.

According to an embodiment, the support unit is a spring holder (denoted 71 in FIG. 3) for holding springs (denoted 72 in FIG. 3) that interface with the rail interface.

According to an embodiment, the lubricant has a high viscosity and will not reach the lubricant inlet if less than a predefined amount of lubricant is stored in the reservoir.

According to an embodiment, the defined amount lubricant exceeds a sum of (a) lubricant required for performing the multiple lubrication iterations and (b) a minimal amount of lubricant that guarantees a flow of the lubricant from the lubricant reservoir to the system.

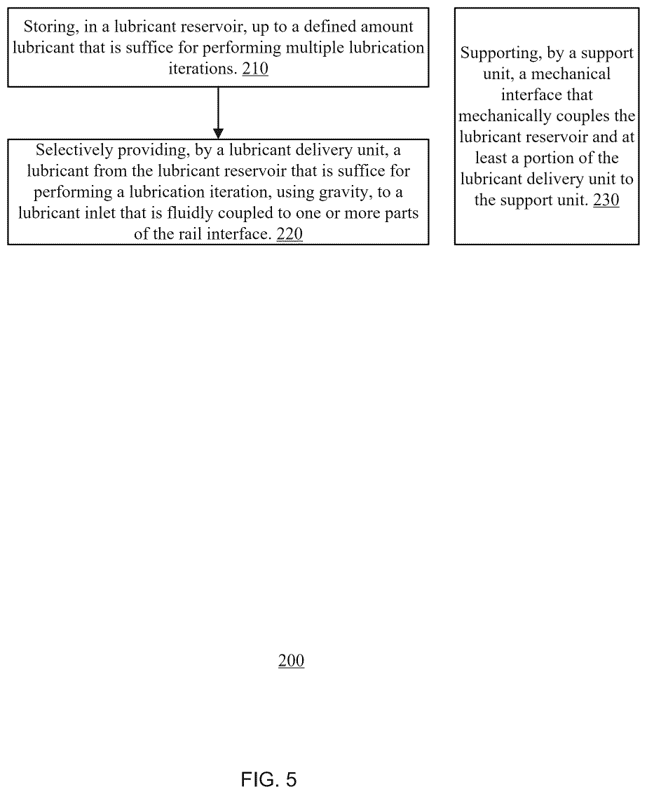

FIG. 5 illustrates an example of method 200 for lubricating a rail interface that is located within a vacuum chamber.

According to an embodiment, method 200 includes step 210 of storing, in a lubricant reservoir, up to a defined amount lubricant that is suffice for performing multiple lubrication iterations.

According to an embodiment, step 210 is followed by step 220 of selectively providing, by a lubricant delivery unit, a lubricant from the lubricant reservoir that is suffice for performing a lubrication iteration, using gravity, to a lubricant inlet that is fluidly coupled to one or more parts of the rail interface.

According to an embodiment, the lubricant delivery unit includes a valve, wherein the selectively providing of step 220 includes opening the valve open during each lubrication iteration and maintaining the valve closed between lubrication iterations.

According to an embodiment, the lubricant delivery unit includes a first lubricant conduit in fluid communication with the lubricant reservoir and a second lubricant conduit in fluid communication with an outlet of the lubricant delivery unit.

According to an embodiment, the selectively providing of step 220 includes selectively fluidly coupling, by the valve, the first lubricant conduit to the second lubricant conduit.

According to an embodiment, the first lubricant conduit is aligned with the second lubricant conduit.

According to an embodiment, the lubricant delivery unit includes a lubricant interface that is mechanically coupled to the rail interface and includes the lubricant inlet. Step 220 utilizes the lubricant interface.

According to an embodiment, the method includes step 230 of supporting, by a support unit, a mechanical interface that mechanically couples the lubricant reservoir and at least a portion of the lubricant delivery unit to the support unit.

According to an embodiment, the method includes at least one of filling the lubricant reservoir, up to the defined amount lubricant, generating an indication that the lubricant reservoir should be filled, monitoring after the lubrication iterations, and the like.

According to an embodiment, the support unit is a spring holder for holding springs that interface with the rail interface.

According to an embodiment, the defined amount lubricant exceeds a sum of (a) lubricant required for performing the multiple lubrication iterations and (b) a minimal amount of lubricant that guarantees a flow of the lubricant from the system.

In the foregoing detailed description, numerous specific details are set forth in order to provide a thorough understanding of the embodiments of the disclosure.

However, it will be understood by those skilled in the art that the present embodiments of the disclosure may be practiced without these specific details. In other instances, well-known methods, procedures, and components have not been described in detail so as not to obscure the present embodiments of the disclosure.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using mechanical components known to those skilled in the art, details will not be explained in any greater extent than that considered necessary as illustrated above, for the understanding and appreciation of the underlying concepts of the present embodiments of the disclosure and in order not to obfuscate or distract from the teachings of the present embodiments of the disclosure.

The term and/or means additionally or alternatively. For example, A and/or B means only A, or only B or A and B.

In the foregoing specification, the embodiments of the disclosure have been described with reference to specific examples of embodiments. It will, however, be evident that various modifications and changes may be made therein without departing from the broader spirit and scope of the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the disclosure described herein are, for example, capable of operation in other orientations than those illustrated or otherwise described herein.

Any reference to the term “comprising” or “having” or “including” should be applied mutatis mutandis to “consisting” and additionally or alternatively should be applied mutatis mutandis to “consisting essentially of.”

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to embodiments containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the embodiments have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system for lubricating a rail interface that is located within a vacuum chamber, the system comprising:
a lubricant reservoir configured store up to a defined amount lubricant that is suffice for performing multiple lubrication iterations; and
a lubricant delivery unit configured to selectively provide, without the use of a pump, a lubricant sufficient for performing a lubrication iteration, using gravity as the exclusive driving force, to a lubricant inlet that is fluidly coupled to one or more parts of the rail interface.

2. The system according to claim 1, wherein the lubricant delivery unit comprises a valve that is opened during each lubrication iteration and is closed between lubrication iterations.

3. The system according to claim 2, wherein the lubricant delivery unit comprises a first lubricant conduit in fluid communication with the lubricant reservoir and a second lubricant conduit in fluid communication with an outlet of the lubricant delivery unit.

4. The system according to claim 3, wherein the valve is configured to selectively fluidly couple the first lubricant conduit to the second lubricant conduit.

5. The system according to claim 3, wherein the first lubricant conduit is aligned with the second lubricant conduit.

6. The system according to claim 1, further comprising a lubricant interface that is mechanically coupled to the rail interface and comprises the lubricant inlet.

7. The system according to claim 1, further comprising a mechanical interface for mechanically coupling the lubricant reservoir and at least a portion of the lubricant delivery unit to a support unit.

8. The system according to claim 7, wherein the support unit is a spring holder for holding springs that interface with the rail interface.

9. The system according to claim 1, wherein the defined amount lubricant exceeds a sum of (a) lubricant required for performing the multiple lubrication iterations and (b) a minimal amount of lubricant that guarantees a flow of the lubricant from the lubricant reservoir.

10. A method for lubricating a rail interface that is located within a vacuum chamber, the method comprising:
storing, in a lubricant reservoir, up to a defined amount lubricant that is sufficient for performing multiple lubrication iterations; and
selectively providing, by a lubricant delivery unit, without the use of a pump, a lubricant from the lubricant reservoir that is sufficient for performing a lubrication iteration, using gravity as the exclusive driving force, to a lubricant inlet that is fluidly coupled to one or more parts of the rail interface.

11. The method according to claim 10, wherein the lubricant delivery unit comprises a valve, wherein the selectively providing comprises opening the valve open during each lubrication iteration and maintaining the valve closed between lubrication iterations.

12. The method according to claim 11, wherein the lubricant delivery unit comprises a first lubricant conduit in fluid communication with the lubricant reservoir and a second lubricant conduit in fluid communication with an outlet of the lubricant delivery unit.

13. The method according to claim 12, wherein the selectively providing comprises selectively fluidly coupling, by the valve, the first lubricant conduit to the second lubricant conduit.

14. The method according to claim 12, wherein the first lubricant conduit is aligned with the second lubricant conduit.

15. The method according to claim 10, wherein the lubricant delivery unit further comprising a lubricant interface which is mechanically coupled to the rail interface and comprises the lubricant inlet.

16. The method according to claim 10, further comprising supporting, by a support unit, a mechanical interface that mechanically couples the lubricant reservoir and at least a portion of the lubricant delivery unit to the support unit.

17. The method according to claim 16, wherein the support unit is a spring holder for holding springs that interface with the rail interface.

18. The method according to claim 10, wherein the defined amount lubricant exceeds a sum of (a) lubricant required for performing the multiple lubrication iterations and (b) a minimal amount of lubricant that guarantees a flow of the lubricant from the lubricant reservoir.

19. A system for lubricating a rail interface located within a vacuum chamber, the system comprising:
a lubricant reservoir configured to store a defined amount of lubricant sufficient for performing multiple lubrication iterations;
a lubricant delivery unit entirely free of any pump and comprising a first lubricant conduit fluidly coupled to the lubricant reservoir and positioned above a second lubricant conduit, a second lubricant conduit fluidly coupled to a lubricant inlet of the rail interface, and a valve disposed between the first and second lubricant conduits and configured to selectively fluidly couple the first lubricant conduit to the second lubricant conduit in response to actuation of the valve;
wherein, during each lubrication iteration, the valve is opened to permit lubricant to flow by gravity from the lubricant reservoir, through the first lubricant conduit, through the valve, and through the second lubricant conduit to the lubricant inlet of the rail interface, and the valve is closed between lubrication iterations to prevent lubricant flow, such that the selective delivery of lubricant is effected solely by gravity without the use of a pump.

20. The system set forth in claim 19, further comprising a spring holder configured to mechanically support at least a portion of the lubricant delivery unit and to delimit movement of the rail interface within the vacuum chamber thereby maintaining alignment of the the lubricant delivery unit relative to the lubricant inlet to improve the accuracy and consistency of lubricant delivery over the multiple lubrication iterations.
